(19) United States
(12) Patent Application Publication
(10) Pub. No.: US 2021/0150974 A1
(43) Pub. Date: May 20, 2021

(54) DISPLAY SYSTEM AND DISPLAY CORRECTION METHOD

(71) Applicant: SAMSUNG ELECTRONICS CO., LTD., Suwon-si (KR)

(72) Inventors: Ho Sik SOHN, Seoul (KR); Seung Jin BAEK, Suwon-si (KR); Kil Soo JUNG, Osan-si (KR); Oh Jae KWON, Suwon-si (KR); Ho Young LEE, Suwon-si (KR)

(73) Assignee: SAMSUNG ELECTRONICS CO., LTD., Suwon-si (KR)

(21) Appl. No.: 16/647,384

(22) PCT Filed: Aug. 31, 2018
(86) PCT No.: PCT/KR2018/010117

§ 371 Date: Mar. 13, 2020

(30) Foreign Application Priority Data
Sep. 15, 2017 (KR) 10-2017-0118311

(51) Int. Cl. G09G 3/32

(52) U.S. Cl. CPC G09G 3/32; G09G 2320/0233; G09G 2320/0242; G09G 2360/141; G09G 2360/147; G09G 2360/16; G09G 2320/0295

(57) ABSTRACT

A display system and a display correction method are disclosed. The display system includes an instrument configured to measure a brightness and a chrominance of each pixel of a display light source; a correction coefficient calculator configured to derive a distribution of a specific color element by analyzing the brightness and the chromaticity of each pixel, compare the distribution of the specific color element with a reference distribution and reduce the distribution of the specific color element to the reference distribution or less, and calculate the correction coefficient of each pixel of the light source by using the brightness and the chromaticity of each pixel and the distribution of the reduced specific color element; and a display configured to correct the brightness and the chromaticity of the light source based on the correction coefficient of each pixel of the light source.

### TECHNICAL FIELD

Embodiments of the present disclosure relate to a display system and a display correction method.

### BACKGROUND ART

Displays have been continuously developed in the direction of having high brightness, high integration, and large size.

Among the above-mentioned displays, since a liquid crystal display (LCD) panel may not emit light by itself, a light emitting diode (LED) in a conventional fluorescent light source is used as a light source of an LCD, and it is complemented by the introduction of a back light unit (BLU) system in which a board having a white LED package is mounted on the outside of an LCD frame. Henceforth, organic light emitting diode (OLED) panels have been mass-produced and new types of displays are being offered.

Meanwhile, for LED displays that emit light by itself, brightness/color uniformity matching is important for image quality. However, when the LEDs formed on the same wafer are driven at the same voltage/current, a difference of 40% to 50% in brightness and 15 nm to 20 nm in wavelength may occur.

The non-uniformity of the LED display may occur due to a difference between LED light source driver chips, a welding problem of LED light source modules, a flatness problem of a module assembly, and a difference in the center axis position of an LED light source.

### DISCLOSURE

### Technical Problem

Therefore, it is an aspect of the present disclosure to provide a display system that can match the brightness and color uniformity of an LED display, and a display correction method.

### Technical Solution

In accordance with an aspect of the present disclosure, a display system includes: an instrument configured to measure the brightness and the chromaticity of each pixel of a display light source; a correction coefficient calculator configured to derive a distribution of a specific color element by analyzing the brightness and the chromaticity of each pixel, compare the distribution of the specific color element with a reference distribution and reduce the distribution of the specific color element to the reference distribution or less, and calculate the correction coefficient of each pixel of the light source by using the brightness and the chromaticity of each pixel and the distribution of the reduced specific color element; and a display configured to correct the brightness and the chromaticity of the light source based on the correction coefficient of each pixel of the light source.

The correction coefficient calculator may derive the distribution of a color element having the lowest light intensity ratio among the plurality of color elements when deriving the distribution of the specific color element.

The plurality of color elements may include a red color element, a green color element, and a blue color element.

The correction coefficient calculator may reduce the distribution based on an average coordinate point of the specific color element distribution, and derives a criterion for confirming that a noise of the other color element is visible in the specific color element as the reference distribution after performing the correction.

The correction coefficient calculator may reduce the distribution to the reference distribution or less based on an average coordinate point of each direction in a first direction of a chromaticity diagram or a second direction which is the vertical direction of the first direction through the distribution analysis of the specific color element.

The correction coefficient of each pixel of the light source may be a 3×3 correction coefficient.

The light source may be a light emitting diode.

In accordance with another aspect of the present disclosure, a display system includes: an instrument configured to obtain the brightness and the chromaticity of each pixel of a display light source; and a correction coefficient calculator configured to derive a distribution of a specific color element by analyzing the brightness and the chromaticity of each pixel, compare the distribution of the specific color element with a reference distribution and then reduce the distribution of the specific color element to the reference distribution or less, calculate the correction coefficient of each pixel of the light source by using the brightness and the chromaticity of each pixel and the distribution of the reduced specific color element, and transmit the calculated correction coefficient of each pixel of the light source to a display.

In accordance with another aspect of the present disclosure, a display correction method includes: measuring the brightness and the chrominance of each pixel of a display light source; deriving a distribution of a specific color element by analyzing the brightness and the chromaticity of each pixel; comparing the distribution of the specific color element with a reference distribution; as a result of the comparison, when the distribution of the specific color element exceeds the reference distribution, reducing the distribution of the specific color element to the reference distribution or less; calculating the correction coefficient of each pixel of the light source by using the brightness and the chromaticity of each pixel and the distribution of the reduced specific color element; and correcting the brightness and the chromaticity of the display light source based on the correction coefficient of each pixel of the light source.

The deriving of the distribution of the specific color element may include deriving the distribution of a color element having the lowest light intensity ratio among the plurality of color elements.

The plurality of color elements may include a red color element, a green color element, and a blue color element.

The display correction method may further include: after measuring the brightness and the chrominance of each pixel of the display light source and before comparing the distribution of the specific color element to the reference distribution, reducing the distribution based on an average coordinate point of the specific color element distribution; performing a correction; and deriving a criterion for confirming that a noise of the other color element is visible in the specific color element as the reference distribution.

The reducing to the reference distribution or less may include reducing to the reference distribution or less based on an average coordinate point of each direction in a first direction of a chromaticity diagram or a second direction which is the vertical direction of the first direction through the distribution analysis of the specific color element.

The correction coefficient of each pixel of the light source may be a 3×3 correction coefficient.

### Advantageous Effects

According to the above-described technical solution, it is possible to expect the effect of improving the image quality of the display by matching the brightness and color uniformity of the LED display.

### DESCRIPTION OF DRAWINGS

FIG. 1 is a view illustrating a configuration of a display system.

FIG. 2 is a view illustrating a configuration of a display.

FIGS. 3 and 4 are exemplary views illustrating the distribution of a color element before correction.

FIGS. 5 to 7 are exemplary views explaining a method of reducing the distribution of the color element.

FIG. 8 is a flowchart explaining a display correction method.

### BEST MODE

Like numerals refer to like elements throughout the specification. Not all elements of the embodiments of the present disclosure will be described, and the description of what are commonly known in the art or what overlaps each other in the embodiments will be omitted. The terms as used throughout the specification, such as “˜ part,” “˜ module,” “˜ member,” “˜ block.” etc., may be implemented in software and/or hardware, and a plurality of “˜ parts,” “˜ modules,” “˜ members,” or “˜ blocks” may be implemented in a single element, or a single “˜ part,” “˜ module,” “˜ member,” or “˜ block” may include a plurality of elements.

It will be further understood that the term “connect” or its derivatives refer both to direct and indirect connection, and the indirect connection includes a connection over a wireless communication network.

The terms “include (or including)” or “comprise (or comprising)” are inclusive or open-ended and do not exclude additional, unrecited elements or method steps, unless otherwise mentioned.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are merely used for convenience of explanation, but not to limit an order of the steps. Thus, unless the context clearly dictates otherwise, the written order may be practiced otherwise.

Hereinafter, an operating principle and embodiments of the present disclosure will be described with reference to the accompanying drawings.

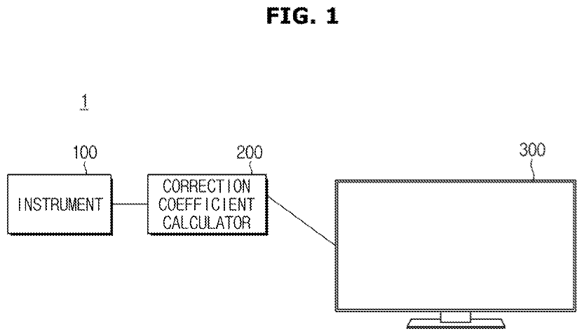

FIG. 1 is a view illustrating a configuration of a display system.

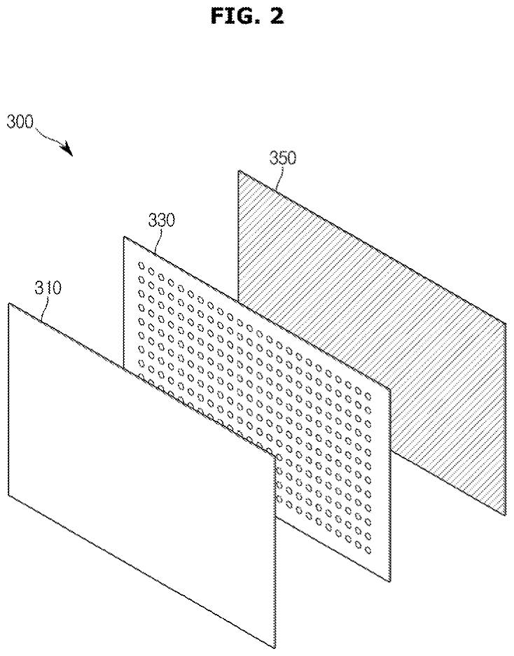

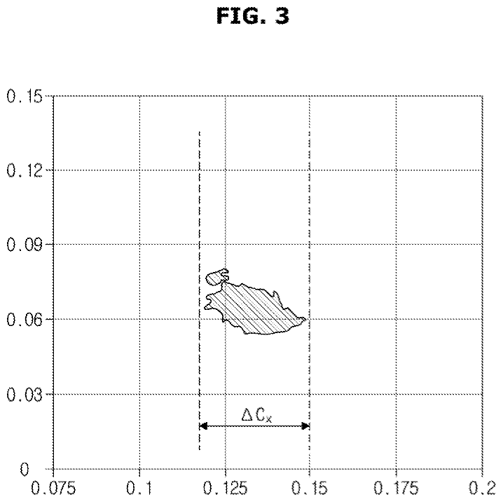

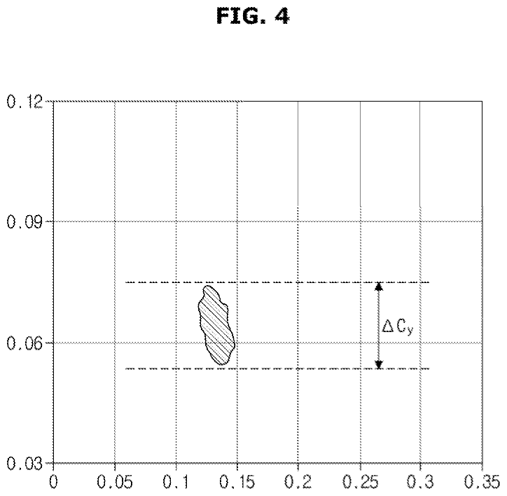

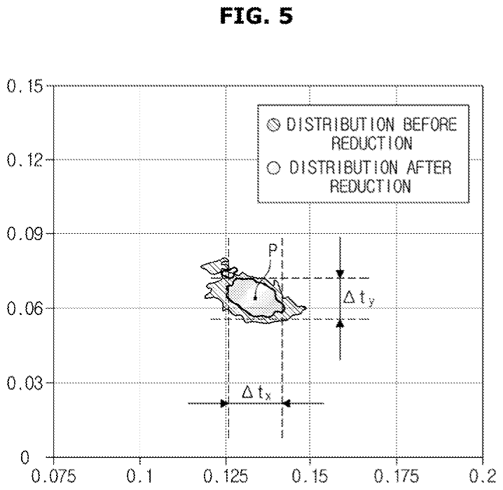

The following description will be made with reference to FIG. 2 illustrating a configuration of a display, FIGS. 3 and 4 are exemplary views illustrating the distribution of a color element before correction, and FIGS. 5 to 7 are exemplary views explaining a method of reducing the distribution of the color element.

Referring to FIG. 1, a display system 1 may include an instrument 100, a correction coefficient calculator 200 and a display 300.

The instrument 100 may measure the brightness and the chromaticity of each pixel of a light source of the display. The light source may be a light emitting diode.

The instrument 100 may obtain the brightness and the chromaticity for a plurality of color elements (e.g., red, green, blue) of each pixel of the light source.

The instrument 100 may be implemented with a spectral photometer or a photoelectric colorimeter, but is not limited thereto and may be applied to any configuration capable of measuring the brightness and the chromaticity of the display. The photoelectric colorimeter may have an optical filter close to a tristimulus value, and the brightness and the chromaticity may be measured by detecting an intensity of a light passing through the optical filter. The spectral photometer may measure the brightness and the chromaticity by separating the light transmitted from the display 300 into wavelength components using a prism, a diffraction grating, or a spectral filter and detecting the intensity of each fundamental wavelength component.

Although not shown, the instrument 100 may include a communicator capable of transmitting and receiving information to and from the correction coefficient calculator 200, and may transmit the measured brightness and chromaticity of each pixel to the correction coefficient calculator 200.

The correction coefficient calculator 200 may derive a distribution of a specific color element by analyzing the brightness and the chromaticity of each pixel.

The correction coefficient calculator 200 may derive the distribution of the color element having the lowest light intensity ratio among the plurality of color elements when deriving the distribution of the specific color element.

The color element having the lowest light intensity ratio among the plurality of color elements may be a blue color element, but is not limited thereto.

The plurality of color elements may include a red color element, a green color element, and the blue color element.

Generally, the intensity ratio of red/green/blue for white balance is 3:6:1, and the corresponding ratio may vary depending on the element characteristics. However, most blue intensity ratios may be the minimum value.

A noise may be generated due to the distribution of a chromaticity diagram of the blue having a relatively low intensity of the light and a light intensity difference between the red and the green may be generated for color uniformity of the display 300.

Based on this principle, the correction coefficient calculator 200 may calculate a correction coefficient for the distribution reduction and a noise reduction based on the distribution of the chromaticity diagram of the blue having the lowest light intensity.

Referring to FIGS. 3 and 4, the correction coefficient calculator 200 may derive the distribution of the specific color element (for example, blue) having the relatively low light intensity ratio by analyzing the brightness and the chromaticity of each pixel transmitted from the instrument 100.

At this time, FIG. 3 illustrates an X-axis distribution (Δcₓ) of the specific color element (e.g., a blue element) before a correction and FIG. 4 illustrates a Y-axis distribution (Δc_{y}) of the specific color element (e.g., a blue element) after the correction.

For example, the correction coefficient calculator 200 may derive the distribution (Δcₓ, Δc_{y}) of the specific color element among the measurement data by the instrument 100 through Equation 1.

Δcₓ=|Max(cₓ)−Min(cₓ)|

Δc_{y}=|Max(c_{y})−Min(c_{y})| [Equation 1]

Δcₓ may denote the X-axis distribution of the specific color element, and Δc_{y} may denote the Y-axis distribution of the specific color element.

The correction coefficient calculator 200 may compare the distribution of the specific color element with the reference distribution and then reduce the distribution of the specific color element to the reference distribution or less, and calculate the correction coefficient of each pixel of the light source by using the brightness and the chromaticity of each pixel and the distribution of the reduced specific color element. At this time, the correction coefficient of each pixel of the light source may be a correction coefficient of 3×3, but is not limited thereto.

The correction coefficient calculator 200 may reduce the distribution to the reference distribution or less based on an average coordinate point (P in FIG. 5) of each direction in a first direction (for example, the X-axis direction) of the chromaticity diagram or a second direction (for example, the Y-axis direction) which is the vertical direction of the first direction through the distribution analysis of the specific color element (refer to FIG. 5). At this time, the reduction of the distribution based on the average coordinate point may be to balance the distribution in each direction.

Meanwhile, when Cx and Cy distributions in the chromaticity diagram of a blue measurement value are large, the noise after the correction can be visually recognized. When the X-axis distribution (Cx distribution) is relatively large, a red noise may be generated. When the Y-axis distribution (Cy distribution) is relatively large, a green noise may be generated.

For example, when a distribution ΔC(Δcx, Δcy) of the measurement chromaticity diagram of the blue (Blue) to remove the noise of the red and the green described above exceeds the reference distribution (threshold distribution) ΔT(Δtx, Δty), the correction coefficient calculator 200 may reduce the distribution so that the blue distribution is less than the reference distribution as shown in FIG. 5, and the correction may be performed to eliminate the noise in blue color.

In FIG. 5, the distribution before a reduction may represent the distribution of the actual measurement values of the specific color element (for example, the blue element) measured through the instrument 100, and the distribution after the reduction may represent the distribution that reduces the distribution of the specific color element to the reference distribution or less.

In the disclosure, since the X-axis and the Y-axis distributions of the measurement value of the specific color element (for example, the blue element) are reduced, the difference between the red and the green light emission amounts between pixels that may be reduced during the correction is applied, and the noise may be removed.

Hereinafter, a method for deriving the reference distribution will be described in detail.

The correction coefficient calculator 200 may reduce the distribution based on the average coordinate point of the specific color element distribution, and derive a criterion for confirming that the noise of the other color element is visible in the specific color element as the reference distribution after performing the correction.

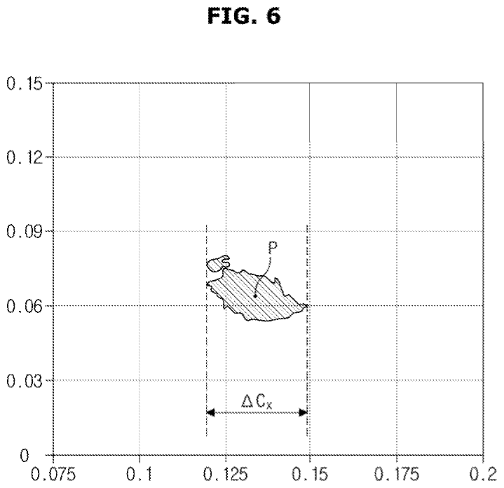

Specifically, the correction coefficient calculator 200 may reduce the distribution based on the average coordinate point (P in FIG. 6) of the specific color element distribution as shown in Equation 2. The distribution reduction may be the reduction of the distribution to derive the reference distribution.

c′ₓ=s·(cₓ·Mean(cₓ))+Mean(cₓ) [Equation 2]

Here, c′ₓ may denote the specific color element distribution whose distribution is reduced, s may denote a weight value that allows the specific color element (for example, the blue element distribution) to be reduced to the distribution or less, Mean(cₓ) may denote an average value of the specific color element distribution, and cₓ−Mean(cₓ) may denote a distance the specific color element distribution is spaced apart from the average value. The s may be 1 or less (s≤1).

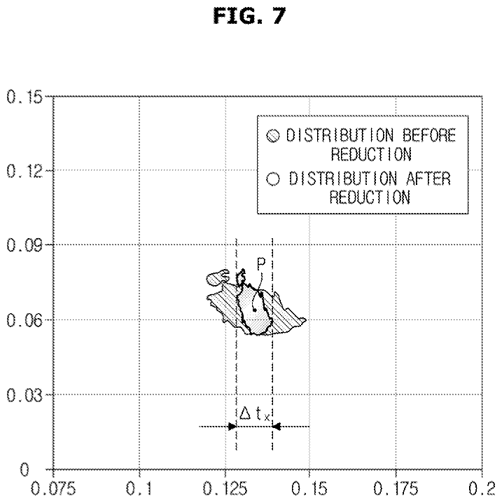

Thereafter, the correction coefficient calculator 200 may perform the correction to derive the reference distribution (Δtx, Δty) in which the noise of the other color element (for example, the red element) is visually confirmed. At this time, FIG. 7 may represent the reference distribution Δtx based on the X-axis coordinate.

At this time, the reference distribution may be derived from Equation 3.

Δtₓ=s·Δcₓ

Δt_{y}=s·Δc_{y} [Equation 3]

Here, s may denote a weight value that allows the specific color element (for example, the blue element distribution) to be reduced to the distribution or less.

Thereafter, the correction coefficient calculator 200 may confirm that the noise of the other color element is removed when the blue distribution is reduced for the other color element (for example, the red element) based on the reference distribution derived through the above process. At this time, the specific color element distribution (c′ₓ) whose distribution is reduced to the reference distribution or less may be expressed by Equation 4.

$${{c}^{′}}_{x} = \frac{{Δt}_{x}}{{Δc}_{x}} \cdot ( {c}_{x} - Mean ( {c}_{x} ) ) + Mean ( {c}_{x} ) \qquad [ Equation 4 ]$$

That is, the correction coefficient calculator 200 may reduce the distribution based on the average coordinate point of the specific color element distribution, and derive the reference distribution in which it is confirmed that the noises of the other color elements are visible with respect to the specific color element through an iterative process of performing the correction.

Although not shown, the correction coefficient calculator 200 may be provided with a communicator capable of transmitting and receiving information to and from the instrument 100 or the display 300, and may receive the brightness and the chromaticity of the measured pixel or transmit the correction coefficient of each pixel of the light source.

The display 300 may correct the brightness and the chromaticity of the light source based on the correction coefficient of each pixel of the light source. Although not shown, the display 300 may include a controller to control the overall display, including calibrating the brightness and the chromaticity of the light source.

Referring to FIG. 2, the display 300 may include a front cover 310 including a glass or the like in a direction in which an image signal is visually displayed and can be viewed by a user, a display panel 330 comprising an LED panel, and a rear cover 350 formed on the rear surface of the display panel 330 to fix the display panel 330 and to function as heat dissipation.

The display panel 330 may have a shape in which an LED chip is formed on a front surface corresponding to the front cover 310.

It is to be understood that the display 300 may further include a polarizing plate for realizing the color by passing or blocking the light in addition to the front cover 310, the display panel 330, and the rear cover 350 described above.

Each of the instrument 100, the correction coefficient calculator 200, and the display 300 may include a communicator, an inputter, a storage, and a controller, respectively.

The communicator may include one or more components for enabling communication with an external device. For example, the communication device 110 may include at least one of a short-range communication module, a wired communication module, and a wireless communication module.

The short-range communication module may include various kinds of short-range communication modules, such as a Bluetooth module, an infrared communication module, a Radio Frequency Identification (RFID) communication module, a Wireless Local Access Network (WLAN) communication module, a Near Field Communication (NFC) module, a Zigbee communication module, and the like, which transmit/receive signals through a wireless communication network at a short range.

The wired communication module may include various cable communication modules, such as a Universal Serial Bus (USB), a High Definition Multimedia Interface (HDMI), a Digital Visual Interface (DVI), Recommended Standard-232 (RS-232), power line communication, Plain Old Telephone Service (POTS), and the like, as well as various kinds of wired communication modules, such as a Local Area Network (LAN) module, a Wide Area Network (WAN) module, a Value Added Network (VAN) module, and the like.

The wireless communication module may include wireless communication modules supporting various wireless communication methods, such as Global System for Mobile Communication (GSM), Code Division Multiple Access (CDMA), Wideband Code Division Multiple Access (WCDMA), Universal Mobile Telecommunications System (UMTS), Time Division Multiple Access (TDMA), Long Term Evolution (LTE), and the like, as well as a Wireless-Fidelity (Wi-Fi) module, and a Wireless Broadband module.

The inputter may be a configuration for allowing the user to input a set value and the like for each operation control.

The inputter may include a hardware device, such as various buttons or switches, a keyboard, and the like for the user's input.

Also, the inputter may include a Graphical User Interface (GUI) such as a touch pad, that is, a software device, for the user's inputs. The touch pad may be implemented as a Touch Screen Panel (TSP), and may be interlayered with the display.

In the case of the Touch Screen Panel (TSP) being interlayered with the touch pad, the display may also be used as the inputter.

The storage may be implemented as at least one of a non-volatile memory device (for example, a cache, ROM, PROM, EPROM, EEPROM, and flash memory), a volatile memory device (for example, RAM), or a storage medium (for example, HDD and CD-ROM), but is not limited thereto. The storage may be memory implemented as a separate chip from the processor described above in regard of the controller, or the storage device and the processor may be integrated into a single chip.

The controller may be implemented with memory (not shown) to store data for algorithms for controlling the operations of the components of the instrument 100, the correction coefficient calculator 200, and the display 300 or programs for executing the algorithms, and a processor (not shown) to perform the above-described operations using the data stored in the memory. The memory and the processor may be implemented as separate chips, or integrated into a single chip.

In addition, the instrument 100 and the correction coefficient calculator 200 may further include the display other than the display 300. When measuring or the correction coefficient is calculated, the related information may be displayed so that the user can visually confirm.

The display may be a Cathode Ray Tube (CRT), a Digital Light Processing (DLP) panel, a Plasma Display Panel (PDP), a Light Crystal Display (LCD) panel, an Electro Luminescence (EL) panel, an Electrophoretic Display (EPD) panel, an Electrochromic Display (ECD) panel, a Light Emitting Diode (LED) panel, or an Organic Light Emitting Diode (OLED) panel, but is not limited thereto.

Meanwhile, the instrument 100, the correction coefficient calculator 200, and the display 300 may be implemented in the same configuration or independently of each other according to the needs of an operator. For example, it is also possible that the instrument 100 and the correction coefficient calculator 200 are implemented together in one configuration, or the correction coefficient calculator 200 and the display 300 are implemented together in one configuration.

On the other hand, it is also possible that the display system 1 may include only the instrument 100 to obtain the brightness and the chromaticity of each pixel of a display light source and the correction coefficient calculator 200. Wherein the correction coefficient calculator 200 may calculate the distribution of the specific color element by analyzing the brightness and the chromaticity of each pixel, compare the distribution of the specific color element with the reference distribution, reduce the dispersion of the specific color element to the reference distribution or less, calculate the correction coefficient of each pixel of the light source by using the brightness and the chromaticity of each pixel, and the distribution of the reduced specific color element of each pixel, and transmit the calculated correction coefficient of each pixel of the light source to the display.

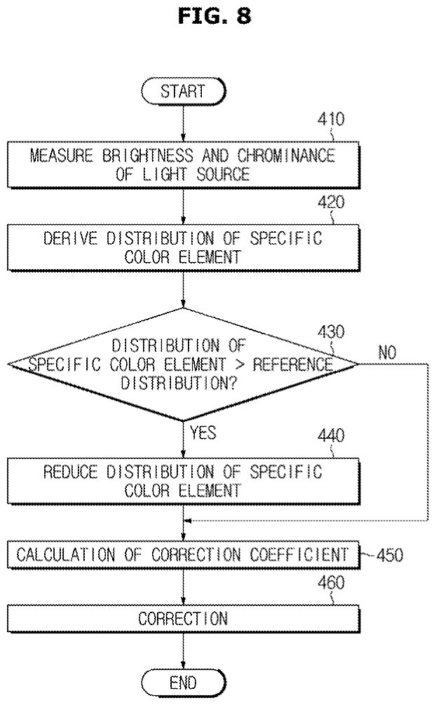

FIG. 8 is a flowchart explaining a display correction method.

Referring to FIG. 8, the instrument 100 of the display system may measure the brightness and the chrominance of each pixel of the display light source (410). The instrument 100 may transmit the brightness and the chrominance of the measured light source to the correction coefficient calculator 200 of each pixel.

Next, the correction coefficient calculator 200 may derive the dispersion of the specific color element by analyzing the brightness and the chromaticity of each pixel (420).

Specifically, the correction coefficient calculator 200 may derive the dispersion of the color element having the lowest light intensity ratio among a plurality of color elements. The plurality of color elements may include the red color element, the green color element, and the blue color element.

Referring to FIGS. 3 and 4, the correction coefficient calculator 200 may derive the dispersion of the specific color element (for example, blue) having the relatively low light intensity ratio by analyzing the brightness and the chromaticity of each pixel transmitted from the instrument 100.

At this time, FIG. 3 illustrates the X-axis distribution (Δcₓ) of the specific color element (for example, the blue element) before the correction, and FIG. 4 illustrates the Y-axis (Δc_{y}) of the specific color element (for example, the blue element) after the correction.

For example, the correction coefficient calculator 200 may derive the distribution (Δcₓ, Δc_{y}) of the specific color element among the measurement data by the instrument 100 through the above-described equation 1.

The correction coefficient calculator 200 may compare the distribution of the specific color element to the reference distribution (430).

As a result of the comparison, when the distribution of the specific color element exceeds the reference distribution, the correction coefficient calculator 200 may reduce the distribution of the specific color element to the reference distribution or less (440).

In step 440, the correction coefficient calculator 200 may reduce the distribution to the reference distribution or less based on the average coordinate point of each direction in the first direction of the chromaticity diagram or the second direction which is the vertical direction of the first direction through the distribution analysis of the specific color element.

Next, the correction coefficient calculator 200 may calculate the correction coefficient of each pixel of the light source using the brightness and the chromaticity of each pixel and the distribution of the specific color element (450). The correction coefficient calculator 200 may transmit the correction coefficients of each pixel of the light source to the display 300. The correction coefficient of each pixel of the light source may be the correction coefficient of 3×3.

Next, the display 300 may correct the brightness and the chromaticity of the light source of the display based on the correction coefficient of each pixel of the light source (460).

On the other hand, as a result of the comparison of step 430, when the dispersion of the particular color element does not exceed the reference dispersion, steps 450 and 460 may be performed.

Although not shown, after measuring the brightness and the chrominance of each pixel of the display light source of step 410 described above, before comparing the distribution of the specific color element of step 430 to the reference distribution, the correction coefficient calculator 200 may reduce the distribution based on the average coordinate point of the specific color element distribution, and derive the criterion that the noise of the other color element is visible in the specific color element as the reference distribution after performing the correction.

Specifically, the correction coefficient calculator 200 may reduce the distribution based on the average coordinate point (P in FIG. 6) of the specific color element distribution, as shown in Equation 2. At this time, the reduction of the dispersion may be the reduction of the dispersion to derive the reference dispersion.

Thereafter, the correction coefficient calculator 200 may perform the correction to derive the reference distribution (Δtx, Δty) from which the noise of the other color element (for example, the red element) is visually confirmed.

Thereafter, the correction coefficient calculator 200 may confirm that the noise of the other color element is removed when the blue distribution is reduced for the same color element (for example, the red element) based on the reference dispersion derived through the above-described process.

That is, the correction coefficient calculator 200 may reduce the distribution based on the average coordinate point of the specific color element distribution, and perform the correction process based on the reference distribution.

As is apparent from the above description, the image quality of the display can improve by matching the brightness and color uniformity of the LED display.

Meanwhile, the embodiments of the present disclosure may be implemented in the form of recording media for storing instructions to be carried out by a computer. The instructions may be stored in the form of program codes, and when executed by a processor, may generate program modules to perform the operation in the embodiments of the present disclosure. The recording media may correspond to computer-readable recording media.

The computer-readable recording medium includes any type of recording medium having data stored thereon that may be thereafter read by a computer. For example, it may be a ROM, a RAM, a magnetic tape, a magnetic disk, a flash memory, an optical data storage device, etc.

The exemplary embodiments of the present disclosure have thus far been described with reference to the accompanying drawings. It will be obvious to people of ordinary skill in the art that the present disclosure may be practiced in other forms than the exemplary embodiments as described above without changing the technical idea or essential features of the present disclosure. The above exemplary embodiments are only by way of example, and should not be interpreted in a limited sense.

1. A display system comprising:
an instrument configured to measure a brightness and a chrominance of each pixel of a display light source;
a correction coefficient calculator configured to derive a distribution of a specific color element by analyzing the brightness and the chromaticity of each pixel, compare the distribution of the specific color element with a reference distribution and reduce the distribution of the specific color element to the reference distribution or less, and calculate the correction coefficient of each pixel of the light source by using the brightness and the chromaticity of each pixel and the distribution of the reduced specific color element; and
a display configured to correct the brightness and the chromaticity of the light source based on the correction coefficient of each pixel of the light source.

2. The display system according to claim 1, wherein the correction coefficient calculator is configured to derive the distribution of a color element having the lowest light intensity ratio among the plurality of color elements when deriving the distribution of the specific color element.

3. The display system according to claim 2, wherein the plurality of color elements comprise a red color element, a green color element, and a blue color element.

4. The display system according to claim 1, wherein the correction coefficient calculator is configured to reduce the distribution based on an average coordinate point of the specific color element distribution, and derive a criterion for confirming that a noise of the other color element is visible in the specific color element as the reference distribution after performing the correction.

5. The display system according to claim 1, wherein the correction coefficient calculator is configured to reduce the distribution to the reference distribution or less based on an average coordinate point of each direction in a first direction of a chromaticity diagram or a second direction which is the vertical direction of the first direction through the distribution analysis of the specific color element.

6. The display system according to claim 1, wherein the correction coefficient of each pixel of the light source is a 3×3 correction coefficient.

7. The display system according to claim 1, wherein the light source is a light emitting diode.

8. A display system comprising:
an instrument configured to obtain a brightness and a chrominance of each pixel of a display light source; and
a correction coefficient calculator configured to derive a distribution of a specific color element by analyzing the brightness and the chromaticity of each pixel, compare the distribution of the specific color element with a reference distribution and then reduce the distribution of the specific color element to the reference distribution or less, calculate the correction coefficient of each pixel of the light source by using the brightness and the chromaticity of each pixel and the distribution of the reduced specific color element, and transmit the calculated correction coefficient of each pixel of the light source to a display.

9. A display correction method comprising:
measuring a brightness and a chrominance of each pixel of a display light source;
deriving a distribution of a specific color element by analyzing the brightness and the chromaticity of each pixel;
comparing the distribution of the specific color element with a reference distribution;
as a result of the comparison, when the distribution of the specific color element exceeds the reference distribution, reducing the distribution of the specific color element to the reference distribution or less;
calculating the correction coefficient of each pixel of the light source by using the brightness and the chromaticity of each pixel and the distribution of the reduced specific color element; and
correcting the brightness and the chromaticity of the display light source based on the correction coefficient of each pixel of the light source.

10. The display correction method according to claim 9, wherein the deriving of the distribution of the specific color element comprises:
deriving the distribution of a color element having the lowest light intensity ratio among the plurality of color elements.

11. The display correction method according to claim 10, wherein the plurality of color elements comprise a red color element, a green color element, and a blue color element.

12. The display correction method according to claim 9, further comprising:
after measuring the brightness and the chrominance of each pixel of the display light source and before comparing the distribution of the specific color element to the reference distribution,
reducing the distribution based on an average coordinate point of the specific color element distribution;
performing a correction; and
deriving a criterion for confirming that a noise of the other color element is visible in the specific color element as the reference distribution.

13. The display correction method according to claim 9, wherein the reducing to the reference distribution or less comprises:
reducing to the reference distribution or less based on an average coordinate point of each direction in a first direction of a chromaticity diagram or a second direction which is the vertical direction of the first direction through the distribution analysis of the specific color element.

14. The display correction method according to claim 9, wherein the correction coefficient of each pixel of the light source is a 3×3 correction coefficient.
